(19) United States
(12) Patent Application Publication
(10) Pub. No.: US 2023/0254470 A1
(43) Pub. Date: Aug. 10, 2023

(54) STEREOSCOPIC IMAGE PICKUP APPARATUS, CONTROL METHOD, STORAGE MEDIUM, AND CONTROL APPARATUS

(71) Applicant: Canon Kabushiki Kaisha, Tokyo (JP)

(72) Inventor: Yuki YOSHIMURA, Tokyo (JP)

(21) Appl. No.: 18/162,030

(22) Filed: Jan. 31, 2023

(30) Foreign Application Priority Data
Feb. 7, 2022 (JP) 2022-017201

(51) Int. Cl. H04N 13/296; H04N 13/239; H04N 13/383; H04N 13/344; H04N 13/128

(52) U.S. Cl. CPC H04N 13/296; H04N 13/128; H04N 13/239; H04N 13/344; H04N 13/383

(57) ABSTRACT

A stereoscopic image pickup apparatus that includes first and second imaging units that acquire first and second images via first and second optical systems, first and second display units that display the first and second images, an eyeball information acquiring unit that acquires eyeball information of a user, an eyeball distance acquiring unit that acquires an eyeball distance of the user that is a distance between rotation centers of left and right eyeballs of the user using the eyeball information, an imaging unit distance adjusting unit that adjusts an imaging unit distance as a distance between the first and second imaging units based on the eyeball distance, and a convergence angle determining unit configured to determine a convergence angle between the first imaging unit and the second imaging unit based on the eyeball distance and distance information to an object specified based on the eyeball information.

### BACKGROUND

### Technical Field

One of the aspects of the disclosure relates to a stereoscopic image pickup apparatus.

### Description of the Related Art

Apparatuses that can capture and display a video on a real-time basis and augment human visual information have recently been widely spread. Especially a head mount display (HMD) allows a user to experience augmented reality (AR) as if a virtual object exists in a real space while its size and distance feeling are expressed.

Persons see things from different perspectives using their right and left eyes, and perceive a sense of depth from a difference between what they see with their left and right eyes (binocular parallax), thereby achieving stereoscopic vision. There are individual differences in stereoscopic vision, and one factor is an individual difference in a distance between both eyes (5 to 7 cm for adults). The different distance between both eyes causes a different convergence angle in viewing an object. Hence, even for an object at the same distance, convergence angles that are different from person to person cause individual differences in the distance feelings in the stereoscopic visions.

Japanese Patent Laid-Open No. (“JP”) 2006-287811 discloses a method of adjusting a convergence angle according to a distance between both eyes manually adjusted by a user in a case where the stereoscopic vision is adjusted with a stereoscopic image pickup apparatus.

However, the stereoscopic image pickup apparatus disclosed in JP 2006-287811 cannot automatically adjust the convergence angle and has difficulty in reproducing the manual adjusting motion of the convergence angle on a real-time basis according to the object distance. In particular, the manual adjustment is unsuitable for the AR display that needs to reproduce a usual distance feeling of a user and to provide a stereoscopic image on a real-time basis.

### SUMMARY

The present invention provides a stereoscopic image pickup apparatus that can provide a stereoscopic image that stably reproduces a distance feeling of a user on a real-time basis.

A stereoscopic image pickup apparatus according to one aspect of the disclosure includes a first imaging unit configured to acquire a first image via a first optical system, a second imaging unit configured to acquire a second image via a second optical system different from the first optical system, a first display unit configured to display the first image, a second display unit configured to display the second image, at least one processor, and a memory coupled to the at least one processor. The memory has instructions that, when executed by the processor, perform operations as an eyeball information acquiring unit configured to acquire eyeball information of a user, an eyeball distance acquiring unit configured to acquire an eyeball distance of the user that is a distance between rotation centers of left and right eyeballs of the user using the eyeball information, an imaging unit distance adjusting unit configured to adjust an imaging unit distance that is a distance between the first imaging unit and the second imaging unit, based on the eyeball distance, and a convergence angle determining unit configured to determine a convergence angle between the first imaging unit and the second imaging unit based on the eyeball distance and distance information to an object specified based on the eyeball information. A control method or apparatus for the above stereoscopic image pickup apparatus also constitutes another aspect of the disclosure. A non-transitory computer-readable storage medium storing a program that causes a computer to execute the above control method also constitutes another aspect of the disclosure.

Further features of the disclosure will become apparent from the following description of exemplary embodiments with reference to the attached drawings. In the following, the term “unit” may refer to a software context, a hardware context, or a combination of software and hardware contexts. In the software context, the term “unit” refers to a functionality, an application, a software module, a function, a routine, a set of instructions, or a program that can be executed by a programmable processor such as a microprocessor, a central processing unit (CPU), or a specially designed programmable device or controller. A memory contains instructions or program that, in a case where executed by the CPU, cause the CPU to perform operations corresponding to units or functions. In the hardware context, the term “unit” refers to a hardware element, a circuit, an assembly, a physical structure, a system, a module, or a subsystem. It may include mechanical, optical, or electrical components, or any combination of them. It may include active (e.g., transistors) or passive (e.g., capacitor) components. It may include semiconductor devices having a substrate and other layers of materials having various concentrations of conductivity. It may include a CPU or a programmable processor that can execute a program stored in a memory to perform specified functions. It may include logic elements (e.g., AND, OR) implemented by transistor circuits or any other switching circuits. In the combination of software and hardware contexts, the term “unit” or “circuit” refers to any combination of the software and hardware contexts as described above. In addition, the term “element,” “assembly,” “component,” or “device” may also refer to “circuit” with or without integration with packaging materials.

### BRIEF DESCRIPTION OF THE DRAWINGS

FIG. 1 illustrates an outline of the system configuration of an HMD.

FIG. 2 schematically illustrates a state in which a user wears the HMD.

FIGS. 3A and 3B explain differences in convergence angles due to differences in distance and differences in convergence angles due to individual differences.

FIG. 4 schematically illustrates an example of a pixel array on an image sensor in an imaging unit.

FIG. 5 schematically illustrates a relationship between a defocus amount and an image shift amount by a pair of focus detecting signals.

FIG. 6 is a flowchart of focus detecting processing.

FIG. 7 is a flowchart of processing for automatically adjusting a convergence angle.

FIG. 8 illustrates an example of a user interface (UI) in acquiring an eyeball distance of a user.

FIG. 9 is a flowchart explaining a method of selectively using the imaging unit distance according to the contents.

FIG. 10 illustrates that the convergence angle is adjusted while the imaging unit distance is larger than the eyeball distance.

FIGS. 11A and 11B are image diagrams before and after shift correction is performed using image processing for reproducing the distance feeling of the user.

FIG. 12 schematically illustrates a method of specifying a target object for the user and of acquiring distance information using eyeball information.

### DESCRIPTION OF THE EMBODIMENTS

Referring now to the accompanying drawings, a detailed description will be given of embodiments according to the disclosure. Corresponding elements in respective figures will be designated by the same reference numerals, and a duplicate description thereof will be omitted.

### First Embodiment

### Configuration of Head Mount Display (HMD)

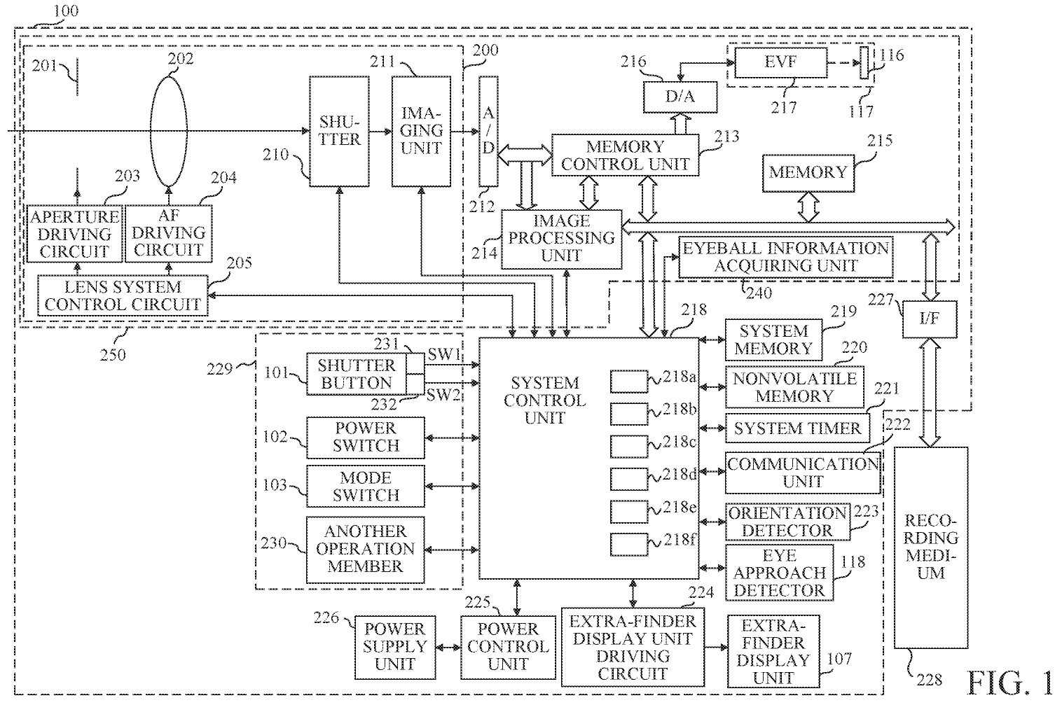

FIG. 1 illustrates an example of a system configuration of an HMD (stereoscopic image pickup apparatus) 100. The HMD 100 has a right-eye imaging/display unit 250R and a left-eye imaging/display unit 250L. Since the right-eye imaging/display unit 250R and the left-eye imaging/display unit 250L have the same configuration, the right-eye imaging/display unit 250R and the left-eye imaging/display unit 250L will be hereinafter simply referred to as an imaging/display unit 250 and described.

The imaging/display unit 250 includes an image capturing unit 200, an A/D converter 212, a memory control unit 213, an image processing unit 214, a memory 215, a D/A converter 216, an electronic viewfinder (EVF) (display unit) 217 (first display unit 217R for the right eye, and a second display unit 217L for the left eye). The image capturing unit 200 includes an aperture stop (diaphragm) 201 and an optical system 202 (a first optical system 202R for the right eye and a second optical system 202L for the left eye). The image capturing unit 200 includes an aperture driving circuit 203, an autofocus (AF) driving circuit 204, a lens system control circuit 205, a shutter 210, an imaging unit 211 (a first imaging unit 211R for the right eye and a second imaging unit 211L for the left eye). The first imaging unit 211R acquires a first image, which is an image for the right eye, via the first optical system 202R. The second imaging unit 211L acquires a second image, which is an image for the left eye, via the second optical system 202L.

The aperture stop 201 is configured so that an aperture diameter is adjustable. The optical system 202 includes a plurality of lenses. The aperture driving circuit 203 adjusts a light amount by controlling the aperture diameter of the aperture stop 201. The AF driving circuit 204 drives the optical system 202 during focusing. The lens system control circuit 205 controls the aperture driving circuit 203 and the AF driving circuit 204 based on instructions from a system control unit 218, which will be described below. The lens system control circuit 205 controls the aperture stop 201 via an aperture driving circuit 203 and provides focusing by displacing the position of the optical system 202 via the AF driving circuit 204.

The shutter 210 is a focal plane shutter that can freely control the exposure time of the imaging unit 211 based on the instruction from the system control unit 218. The imaging unit 211 includes an image sensor that has a CCD, a CMOS element, or the like that converts an optical image into an electrical signal. The imaging unit 211 may include an imaging-plane phase-difference sensor that outputs defocus information to the system control unit 218. The A/D converter 212 converts an analog signal output from imaging unit 211 into a digital signal. The image processing unit 214 performs predetermined processing (pixel interpolation, resize processing such as reduction, color conversion processing, etc.) for data from the A/D converter 212 or data from the memory control unit 213. The image processing unit 214 performs predetermined calculation processing using captured image data. The system control unit 218 performs exposure control and distance measurement control based on the obtained calculation result. Through this processing, through-the-lens (TTL) AF processing, auto-exposure (AE) processing, electronic flash pre-emission (EF) processing, and the like are performed. The image processing unit 214 performs predetermined calculation processing using the captured image data, and performs TTL Auto White Balance (AWB) processing based on the obtained calculation result.

The image data from the A/D converter 212 is written in the memory 215 via the image processing unit 214 and the memory control unit 213. Alternatively, the image data from the A/D converter 212 is written to the memory 215 via the memory control unit 213 without using the image processing unit 214. The memory 215 stores image data obtained by the imaging unit 211 and converted into digital data by the A/D converter 212 and image data to be displayed on the EVF 217. The memory 215 has a storage capacity sufficient to store a predetermined number of still images, moving images, and audio data for a predetermined time. The memory 215 also serves as an image display memory (video memory).

The D/A converter 216 converts the image display data stored in the memory 215 into an analog signal and supplies it to the EVF 217. Therefore, the image data for display written in the memory 215 is displayed on the EVF 217 via the D/A converter 216. The EVF 217 performs display according to the analog signal from D/A converter 216. The EVF 217 is, for example, a display such as LCD or organic EL. The digital signal A/D-converted by the A/D converter 212 and stored in the memory 215 is converted into the analog signal by the D/A converter 216 and sequentially transferred to the EVF 217 for display, and thereby a live-view image is displayed. The imaging/display unit 250 has been thus described.

The HMD 100 includes the system control unit 218. The system control unit 218 is a control unit that includes at least one processor and/or at least one circuit. That is, the system control unit 218 may be a processor, a circuit, or a combination of a processor and a circuit. The system control unit 218 controls the entire HMD 100. The system control unit 218 executes the programs recorded in a nonvolatile memory 220 to implement each functional unit described below, and implements each process of the flowcharts described below. The system control unit 218 also performs display control by controlling the memory 215, the D/A converter 216, the EVF 217, and the like.

The HMD 100 further includes a system memory 219, a nonvolatile memory 220, a system timer 221, a communication unit 222, an orientation detector 223, and an eye approach detector 118.

A RAM, for example, is used for the system memory 219. In the system memory 219, constants and variables for operations of the system control unit 218, programs read out of the nonvolatile memory 220, and the like are developed. The nonvolatile memory 220 is an electrically erasable/recordable memory, such as an EEPROM. Constants, programs, and the like for operations of the system control unit 218 are recorded in the nonvolatile memory 220. The programs here are programs for executing flowcharts to be described below. The system timer 221 is a timer that measures the time for various controls and the time of the built-in clock. The communication unit 222 transmits and receives video and audio signals to and from an external device connected wirelessly or by a wired cable. The communication unit 222 can be connected to a wireless Local Area Network (LAN) and the Internet. The communication unit 222 can also communicate with an external device using Bluetooth (registered trademark) or Bluetooth Low Energy. The communication unit 222 can transmit images (including live images) captured by the imaging unit 211 and images recorded on the recording medium 228, and can receive image data and other various information from external devices. The orientation detector 223 detects the orientation of the HMD 100 relative to the gravity direction. Based on the orientation detected by the orientation detector 223, whether the image captured by the imaging unit 211 is an image captured with the horizontally held HMD 100 or an image captured with the vertically held HMD 100. The system control unit 218 can add orientation information corresponding to the orientation detected by the orientation detector 223 to the image file of the image captured by the imaging unit 211, and rotate and record the image. For example, an acceleration sensor, a gyro sensor, or the like can be used for the orientation detector 223. A motion of the HMD 100, such as panning, tilting, lifting, and a stationary state of the HMD 100 can be detected using the orientation detector 223.

The eye approach detector 118 can detect the approach of any object to the eyepiece unit 116 of the eyepiece finder 117 incorporating the EVF 217. The eye approach detector 118 can use, for example, an infrared proximity sensor. In a case where an object approaches it, the infrared rays projected from a light projector of the eye approach detector 118 are reflected on the object and received by a light receiver of the eye approach detector 118. The distance from the eyepiece unit 116 to the object can be determined by the received infrared light amount. Thus, the eye approach detector 118 performs eye proximity detection for detecting the proximity distance of an object to the eyepiece unit 116. The eye approach detector 118 is an eye contact detecting sensor that detects the approach (eye contact) and separation (eye separation) of the eye (object) to and from the eyepiece unit 116 of the eyepiece finder 117. In a case where an object approaching the eyepiece unit 116 within a predetermined distance from the eyepiece unit 116 is detected from the non-eye approach state, the eye approach detector 118 detects the approach of the eye (object). On the other hand, the eye approach detector 118 detects the separation (eye separation or departure) of the eye (object) in a case where the object whose approach has been detected moves away from the eye approach state (approaching state) by a predetermined distance or more. A threshold for detecting the approach of the object (eye approach) and a threshold for detecting the separation of an object (eye separation) may be different, for example, by providing hysteresis. It is assumed that after the approach of the object (eye approach) is detected, the eye approach (eye contact) state is maintained until the separation of the object (eye separation) is detected. It is assumed that after the separation of the object (eye separation) is detected, the eye separation state is maintained until the approach of the object (eye contact) is detected. The system control unit 218 switches between display (display state) and non-display (non-display state) of the EVF 217 according to the state detected by the eye approach detector 118. More specifically, the system control unit 218 puts the EVF 217 into the non-display state at least in the imaging standby state and in a case where the switching of the EVF 217 is set to automatic switching. The system control unit 218 puts the EVF 217 into a display state while the approach of the eye (object) is detected. The eye approach detector 118 is not limited to the infrared proximity sensor, and may use another sensor as long as it can detect a state that can be considered to be the eye (object) approaching state.

The HMD 100 further includes an extra-finder display unit 107, an extra-finder display unit driving circuit 224, a power control unit 225, a power supply unit 226, a recording medium interface (I/F) 227, an operation unit 229, and an eyeball information acquiring unit 240. The system control unit 218 and eyeball information acquiring unit 240 constitute a control apparatus.

The power control unit 225 includes a battery detecting circuit, a DC-DC converter, a switching circuit for switching blocks to be energized, and the like, and detects whether or not a battery is installed, a battery type, and a remaining battery amount. The power control unit 225 controls the DC-DC converter based on the detection results and instruction from the system control unit 218, and supplies the necessary voltage to each component including the recording medium 228 for the necessary period. The power supply unit 226 is a primary battery such as an alkaline battery or a lithium battery, a secondary battery such as a NiCd battery, a NiMH battery or a Li battery, an AC adapter, or the like. The recording medium I/F 227 is an interface with a recording medium 228 such as a memory card or hard disk drive. The recording medium 228 is a memory card or the like for recording captured images, and includes a semiconductor memory, a magnetic disk, or the like. The recording medium 228 may be detachable or may be built-in.

The operation unit 229 is an input unit that accepts an operation (user operation) from the user, and is used to input a variety of instructions to the system control unit 218. The operation unit 229 includes a shutter button 101, a power switch 102, a mode switch 103, another operation unit 230, and the like. The other operation unit 230 includes an electronic dial, a direction key, a menu button, and the like.

The shutter button 101 includes a first shutter switch 231 and a second shutter switch 232. The first shutter switch 231 is turned on when the shutter button 101 is half-pressed (imaging preparation instruction), and generates a first shutter switch signal SW1. The system control unit 218 starts imaging preparation processing such as AF processing, AE processing, AWB processing, and EF processing in response to the first shutter switch signal SW1. The second shutter switch 232 is turned on when the operation of the shutter button 101 is completed, that is, when the shutter button 101 is fully pressed (imaging instruction), and generates a second shutter switch signal SW2. The system control unit 218 starts a series of imaging processing from signal reading from the imaging unit 211 to generating an image file including a captured image and writing it into the recording medium 228 in response to the second shutter switch signal SW2.

A mode switch 103 switches the operation mode of the system control unit 218 among an imaging/display mode, a playback mode, an AR display mode, and the like. The mode switch 103 allows the user to directly switch the operating mode among the above modes. Alternatively, after once confirming the display of an operation mode list screen by the mode switch 103, the user may selectively switch the operation mode among the plurality of displayed modes using the operation unit 229.

The eyeball information acquiring unit 240 first acquires eyeball image data of the user of the HMD 100, calculates (acquires) eyeball information such as visual line information and eyeball position information of the user based on the eyeball image data, and sends the eyeball information to the system control unit 218. The system control unit 218 calculates an eyeball distance and a convergence angle of the user, which will be described below, using the eyeball information such as the visual line information and the eyeball position information. Here, the eyeball distance is defined as a distance between rotation centers of the left and right eyeballs.

### Configuration of HMD

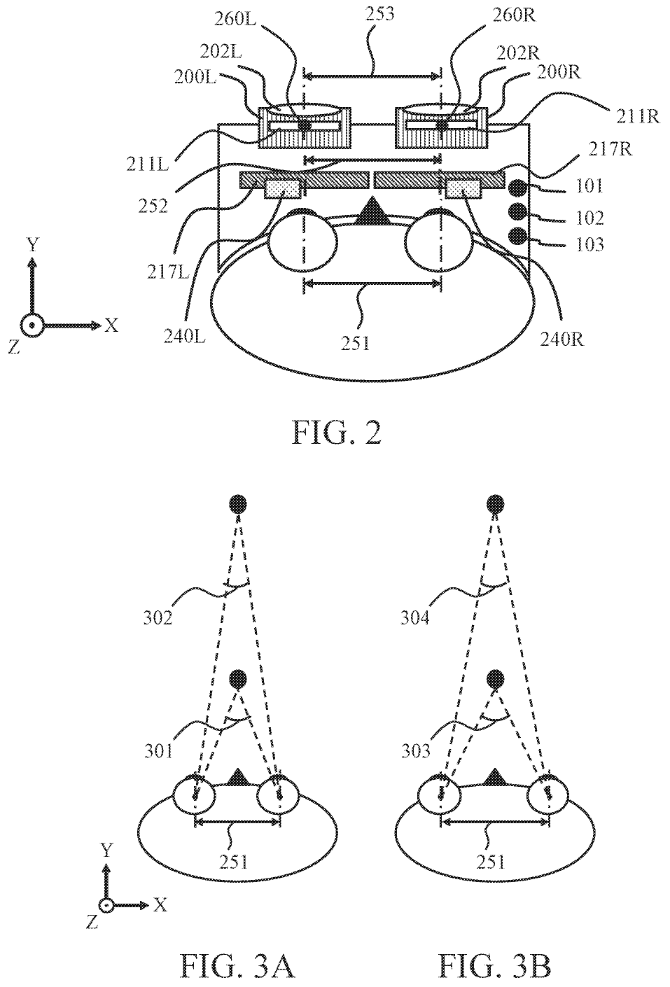

FIG. 2 schematically illustrates the user wearing the HMD 100. Those elements in the HMD 100 illustrated in FIG. 2, which are corresponding elements in FIG. 1, will be designated by the same reference numerals and a description thereof will be omitted.

Reference numeral 260 (260R, 260L) represents a rotation adjuster of the image capturing unit 200. The rotation adjuster 260 is configured to rotate in a Yaw direction around the Z-axis to adjust the convergence angle of the captured image. Reference numeral 251 denotes an eyeball distance of the user. Reference numeral 252 denotes a distance (EVF distance) between the EVF 217R for the right eye and the EVF 217L for the left eye. This embodiment will be described on the premise that the size of the EVF distance 252 can be changed by an unillustrated adjustment mechanism. Since there are individual differences in human eyeball distance 251, the EVF distance 252 of the HMD 100 may be also adjustable. Reference numeral 253 denotes a distance between the imaging unit 211R for the right eye and the imaging unit 211L for the left eye (imaging unit distance). The rotation adjuster 260R for the right eye and the rotation adjuster 260L for the left eye always maintain the imaging unit distance 253 and are configured to simulate the center of the human eyeball. In this embodiment, a description will be given on the assumption that the size of the imaging unit distance 253 can be changed by an unillustrated adjustment mechanism.

FIGS. 3A and 3B explain a convergence angle difference caused by an object distance difference and a convergence angle difference caused by an individual difference, respectively. FIG. 3A illustrates the difference in the convergence angle due to the difference in the distance to the object for a person with a narrow eyeball distance 251, and FIG. 3B illustrates the difference in the convergence angle due to the difference in the distance to the object for a person with a wide eyeball distance 251. Reference numerals 301 and 303 denote convergence angles in a case where the person is viewing a close object. Reference numerals 302 and 304 denote convergence angles in a case where the person is viewing a distant object.

When the convergence angle 301 and convergence angle 302 are compared in FIG. 3A, it is understood that the convergence angle 301 in the case where the person is viewing the close object is larger than the convergence angle 302 in the case where the person is viewing the distant object. Humans perceive this difference in convergence angle due to changes in distance as a distance feeling. It is understood from FIGS. 3A and 3B that the convergence angle is determined by the eyeball distance 251 and the distance to the object. It is therefore understood that if the eyeball distance 251 is different, the convergence angle is different. The individual difference in the eyeball distance 251 is significant, and it is said to be about 5 to 7 [cm] for adults. Therefore, even in viewing a three-dimensional image with the same convergence angle, the distance feeling is different for each individual.

Some AR images deal with a distance between a virtual object and the user. In particular, in experiencing sports or sightseeing on the AR, reproducing a distance feeling to an object can provide the user with a more realistic experience and less discomfort. It is thus required to provide a three-dimensional image close to the distance feeling of the user. In order to provide the three-dimensional image that reproduces the distance feeling of the user, it is necessary that the eyeball distance 251 and the imaging unit distance 253 illustrated in FIG. 2 coincide with each other and that the convergence angle of the image capturing unit 200 and the convergence angle of the user coincide with each other.

A general acquiring method of the human convergence angle is a method of detecting visual line information of the left and right eyes with the eyeball information acquiring unit 240 disposed on the display such as the EVF 217, and of calculating the convergence angle based on the visual line information of the left and right eyes. However, this method has difficulty in accurately acquiring the convergence angle on a real-time basis, because human eyeball motions have elements that make unstable the visual lines, such as saccades and fixational microtremors. In order to stably acquire accurate visual line information, it is thus necessary to use visual line information that has been acquired by averaging a plurality of pieces of visual line information. In addition, the detection accuracy of the visual line information is likely to change depending on the visual line direction and individual differences. A description will now be given of a method of calculating the convergence angle of the user using distance information.

This embodiment will discuss a method of acquiring distance information to an object viewed by the user using an image sensor that can calculate defocus information, and focal length information and the defocus information of the optical system 202 as an imaging optical system. A calculating method of the defocus information will be described below. However, the measure for acquiring the distance information is not limited to that of this embodiment, and a distance information acquiring unit such as an active distance measuring unit using a laser or the like may be separately provided, and the distance information may be acquired by the distance information acquiring unit. As long as the distance information can be finally acquired, the effects of this embodiment will not be impaired and thus the method of acquiring the distance information itself is not limited.

### Configuration of Image Sensor in Imaging Unit

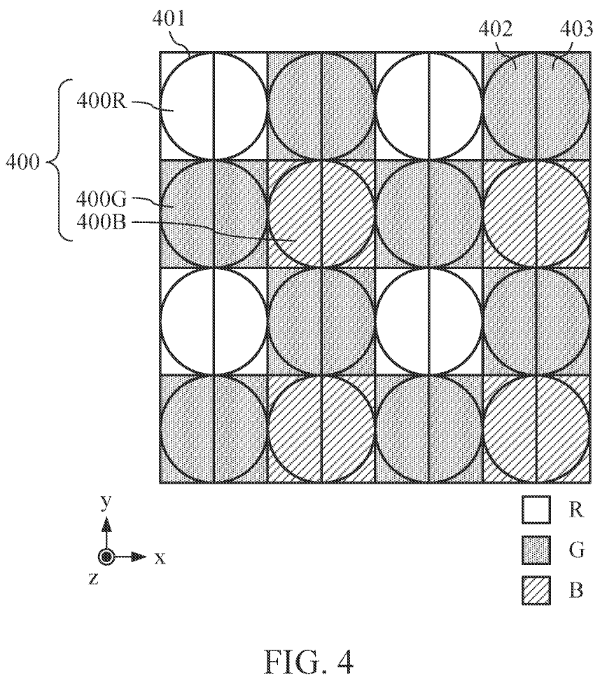

FIG. 4 schematically illustrates a pixel array of the image sensor within the imaging unit 211 according to this embodiment. FIG. 4 illustrates the pixel array of the two-dimensional CMOS sensor as the image sensor in the imaging unit 211 according to this embodiment, in a range of 4 columns × 4 rows of imaging pixels (which corresponds to a range of 8 columns × 4 rows as an array of focus detecting pixels).

In this embodiment, a pixel unit 400 consists of 2 columns × 2 rows of pixels and is covered with a Bayer array color filter. In the pixel unit 400, a pixel 400R having R (red) spectral sensitivity is located at the upper left position, a pixel 400G having G (green) spectral sensitivity is located at the upper right and lower left positions, and a pixel 400B having B (blue) spectral sensitivity is located at the lower right position. In order for the image sensor in the imaging unit 211 according to this embodiment to perform focus detection using the imaging-plane phase-difference method, each pixel has a plurality of photodiodes (photoelectric conversion units) for a single microlens 401. In this embodiment, each pixel includes two photodiodes 402 and 403 arranged in two columns × one row. The image sensor in the imaging unit 211 is formed by arranging a large number of pixel units 400 on the imaging plane, each consisting of 2 columns × 2 rows of pixels (4 columns × 2 rows of photodiodes) illustrated in FIG. 4, and enables an imaging signal and a focus detecting signal to be acquired.

In each pixel having such a configuration, a light beam is separated by the microlens 401 and images are formed on the first photodiode 402 and the second photodiode 403. A signal (A+B signal) obtained by adding the signals from the two photodiodes 402 and 403 is used as an imaging signal, and a pair of signals (A image signal and B image signal) read out of each of the photodiodes 402 and 403 are used as focus detecting signals. The imaging signal and the focus detecting signal may be individually read out, but they may be acquired as follows in consideration of the processing load. That is, the imaging signal (A+B signal) and one of the signals of the photodiodes 402 and 403 (for example, the A image signal) are read out, and the other signal (for example, the B image signal) is obtained by calculating the difference. In this embodiment, each pixel is configured to have two photodiodes 402 and 403 for the single microlens 401, but the number of photodiodes is not limited to two. A plurality of pixels having different opening positions of the light receiving portion for the microlens 401 may be provided. In other words, any configuration may be used as long as two signals for phase difference detection such as an A image signal and a B image signal are finally obtained.

Although FIG. 4 illustrates a configuration in which all pixels have a plurality of photodiodes, the disclosure is not limited to this example. A configuration in which the detection pixels are discretely provided may be used.

### Relationship Between Defocus Amount and Image Shift Amount

A description will now be given of a relationship between a defocus amount as the defocus information calculated from the pair of signals (A image signal and B image signal) acquired by the image sensor according to this embodiment and the image shift amount. A general optical system in which the imaging center and the optical axis center coincide will be described below. In this embodiment, the same image sensor is incorporated in each of the imaging/display unit 250R for the right eye and the imaging/display unit 250L for the left eye. A description will be given of an example that calculates a defocus amount using only the imaging/display unit 250R for the right eye and calculates distance information from the defocus amount. However, depending on a purpose, a defocus amount may be calculated with each of the imaging/display unit 250R for the right eye and the imaging/display unit 250L for the left eye, and distance information may be acquired by combining the defocus amounts. The distance information may be acquired using only one of the image sensor for the imaging/display unit 250R for the right eye and the image sensor for the imaging/display unit 250L for the left eye image sensor, which one can detect the defocus amount. As described above, as long as the distance information can be finally acquired, the effects of this embodiment will not be impaired and the method of acquiring the distance information itself is not limited.

FIG. 5 schematically illustrates a relationship between a defocus amount d as the defocus information and an image shift amount between a pair of focus detecting signals (A image signal and B image signal). The image sensor (not illustrated) according to this embodiment is disposed on an imaging plane 500, and an exit pupil of the imaging optical system is divided into a first pupil partial area 503 and a second pupil partial area 504.

The magnitude |d| of the defocus amount d is defined as a distance from the imaging position of the object to the imaging plane 500. The sign of the defocus amount d is negative (d<0) in a case where the object is in a front focus state where the imaging position of the object is closer to the object than the imaging plane 500, and is positive (d>0) in a case where the object is in a rear focus state where the imaging position of the object is on the opposite side of the object from the imaging plane 500. In an in-focus state in which the imaging position of the object is on the imaging plane 500 (in-focus position), d=0. In FIG. 5, an object 501 illustrates an example of an in-focus state (d=0), and an object 502 illustrates an example of a front focus state (d<0). The front focus state (d<0) and the rear focus state (d>0) will be collectively referred to as a defocus state (|d|>0).

In the front focus state (d<0), one of the light beams from the object 502, which has passed through a first pupil partial area 503 (second pupil partial area 504) is once condensed, then spreads over a width Γ1 (Γ2) around a center-of-gravity position G1 (G2) of the light beam as a center, and forms a blurred image on the imaging plane 500. The blurred image is received by the first photodiode 402 (second photodiode 403) forming each pixel arranged in the image sensor, and a focus detecting signal (A image signal, B image signal) is generated. Therefore, the focus detecting signals (A image signal, B image signal) are recorded as an object image in which the object 502 is blurred with a width of Γ1 (Γ2) around the center-of-gravity position G1 (G2) on the imaging plane 500. The blur width Γ1 (Γ2) of the object image approximately proportionally increases as the magnitude |d| of the defocus amount d increases. Similarly, the magnitude |p| of the image shift amount p of the object image between the first focus detecting signal (A image signal) and the second focus detecting signal (B image signal) (=difference G1-G2 in the center-of-gravity position of the light beam) also approximately proportionally increases as the magnitude |d| of the defocus amount d increases. This is similarly applied to the rear focus state (d>0), although an image shift direction of an object image between a pair of focus detecting signals is opposite to that of the front focus state.

Therefore, this embodiment can calculate the defocus amount d using a conversion coefficient K for converting the previously acquired image shift amount p into the defocus amount d and the image shift amount p of the object image between the pair of focus detecting signals. The conversion coefficient K is a value that depends on the imaging optical system, and depends on the incident angle, F-number, and optical axis position of the imaging optical system.

### Flow of Defocus Amount Calculation

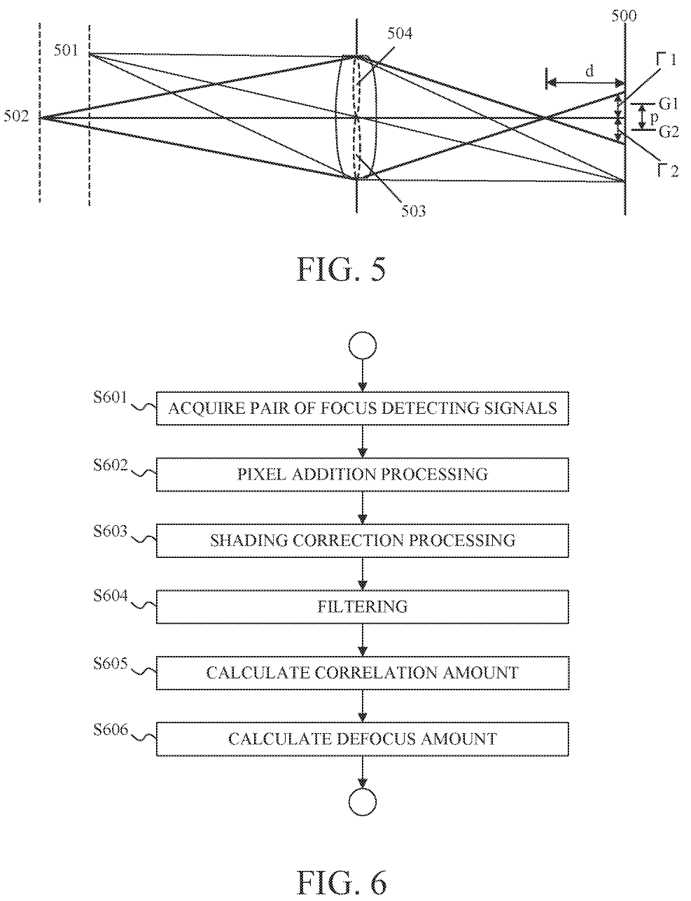

FIG. 6 schematically illustrates a series of the flow of the focus detecting processing according to this embodiment, which is performed by the system control unit 218. The flowchart of FIG. 6 illustrates the processing executed according to the computer program in the system control unit 218 according to this embodiment. The optical system 202R for the right eye and the optical system 202L for the left eye have different in-focus positions due to mechanical factors and the like, but have no difference in the focus detecting processing method. Therefore, the flow of the focus detecting processing will be described below without distinguishing between the optical system 202R for the right eye and the optical system 202L for the left eye.

This embodiment generates a first focus detecting signal by collecting a light receiving signal of the first photodiode 402 of each pixel in the image sensor, and generates a second focus detecting signal by collecting a light receiving signal of the second photodiode 403 of each pixel. More specifically, both the first focus detecting signal and the second focus detecting signal use a signal Y calculated by adding outputs from four pixels of green (G), red (R), blue (B), and green (G). In the phase difference AF, the defocus amount d is calculated (detected) from the image shift amount p between the two focus detecting signals Y.

In step S601, the system control unit 218 generates the first focus detecting signal (A image signal) from the received light signal of the first photodiode 402 in the focus detecting area, and generates the second focus detecting signal (B image signal) from the received light signal of the second photodiode 403 in the focus detecting area.

In step S602, for each focus detecting signal, the system control unit 218 performs pixel addition processing in the column direction to suppress a signal data amount, and further performs addition processing of RGB signals to generate the Y signal. A combination of these two addition processes forms the pixel addition processing. In a case where the number of added pixels is 2, the pixel pitch becomes twice, so the Nyquist frequency is ½ as high as that in the non-addition state. In a case where the number of added pixels is 3, the pixel pitch becomes three times, so the Nyquist frequency is ⅓ as high as that in the non-addition state.

In step S603, the system control unit 218 performs shading correction processing (optical correction processing) for the first focus detecting signal and the second focus detecting signal so that intensities of the first focus detecting signal and the second focus detecting signal coincide with each other. The shading correction value is a value that depends on the imaging optical system, and depends on the incident angle, F-number, and optical axis position of the imaging optical system.

In step S604, the system control unit 218 performs bandpass filtering with a specific frequency band for the first and second focus detecting signals in order to improve the correlation (signal matching degree) between the first and second focus detecting signals and improve focus detecting accuracy. Examples of the bandpass filter include a differential filter such as {1, 4, 4, 4, 0, -4, -4, -4, -1} that cuts DC components and extracts edges, and an additive filter such as {1, 2, 1} that suppresses high-frequency noise components.

Next, in step S605, the system control unit 218 performs shift processing for shifting the filtered first focus detecting signal and second focus detecting signal relative to each other in the pupil dividing direction, and calculates a correlation amount representing the signal matching degree.

The correlation amount COR(s) is calculated by the following equation (1):

$$C O R \left(s\right) = {\sum }_{k ∈ W} \left|A \left(k\right) - B \left(k - s\right)\right| , s ∈ \text{Γ}$$

where A(k) is a filtered k-th first focus detecting signal, B(k) is a filtered k-th second focus detecting signal, W is a range of number k corresponding to the focus detecting area, s is a shift amount by the shift processing, and Γ is a shift range of the shift amount s.

The system control unit 218 generates a shift subtraction signal through shift processing with the shift amount s by correlating and subtracting the k-th first focus detecting signal A(k) and the (k-s)-th second focus detecting signal B(k-s). The system control unit 218 calculates the absolute value of the generated shift subtraction signal, sums the number k within the range W corresponding to the focus detecting area, and calculates the correlation amount COR(s). If necessary, the correlation amount calculated for each row may be added over a plurality of rows for each shift amount. In calculating COR(s), the reliability of the defocus amount in the latter stage can be evaluated based on a value such as a changing amount and peak and bottom values.

In step S606, the system control unit 218 obtains the image shift amount p by calculating a real-valued shift amount that minimizes the correlation amount from the calculated correlation amount using the sub-pixel calculation. The system control unit 218 calculates (detects) the defocus amount d by multiplying the image shift amount p by the conversion factor K. The reliability of the defocus amount in the latter stage can be evaluated based on the magnitude of the conversion factor K.

Using the thus obtained defocus amount and lens focal length information can provide distance information.

### Automatic Adjusting Method of Convergence Angle That Reproduces Distance Feeling of User Using Eyeball Information

In order to reproduce a three-dimensional image that reproduces the distance feeling of the user on a real-time basis with a stereoscopic image pickup apparatus, it is insufficient to simply reproduce the convergence angle of the user and it is necessary to reproduce the convergence angle of the user after the eyeball distance 251 and the imaging unit distance 253 illustrated in FIG. 2 coincide with each other. In a case where the eyeball distance 251 and the imaging unit distance 253 coincide with each other, it is important that the eyeball distance 251 is defined as an amount having a uniform value that does not depend on the distance information to the object, as illustrated in FIG. 2, and is defined by using rotation centers of the left and right eyeballs (that is, the eyeball distance 251 is defined as a distance between the rotation centers of the left and right eyeballs). A value similar to the eyeball distance 251 is a pupillary distance, but the pupillary distance changes according to the object distance. Hence, handling the pupillary distance as user information is likely to become complicated.

An effective way to acquire the eyeball distance 251 is to acquire visual line information in a case where the user views the same image with both eyes. The case where the user views the same image with the left and right eyes corresponds to a case where the user views an object at infinity. Unless the user has strabismus or the like, the visual lines of the right eye and the left eye are parallel, and the eyeball distance 251 and the pupillary distance between the left and right eyes coincide with each other. The eyeball distance 251 can be measured relatively easily even with the eyeball information acquiring unit 240 according to this embodiment, which is a general visual line detecting apparatus. The pupillary distance between the left and right eyes can be acquired from the visual line information by combining the pupil position information and the arrangement information in the HMD of the eyeball information acquiring unit 240, since the pupil position information can be acquired in the visual line detection.

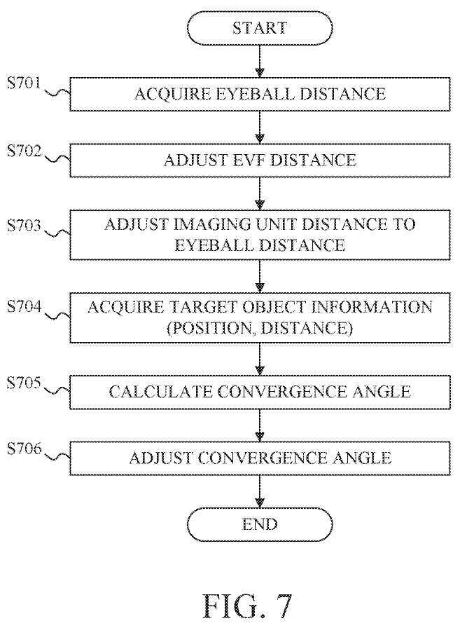

FIG. 7 is a flowchart for automatically adjusting the convergence angle performed by the system control unit 218 in order to reproduce a three-dimensional image that reproduces the distance feeling of the user on a real-time basis with the stereoscopic image pickup apparatus. The flowchart of FIG. 7 illustrates processing executed according to the computer program in the system control unit 218 in this embodiment. A block diagram illustrating a functional configuration of the system control unit 218 is illustrated inside the block of the system control unit 218 in FIG. 1. The system control unit 218 includes, as its functional configuration, an eyeball distance acquiring unit 218a, an EVF distance adjusting unit 218b, an imaging unit distance adjusting unit 218c, a distance information acquiring unit 218d, a convergence angle determining unit 218e, and a convergence angle adjusting unit 218f.

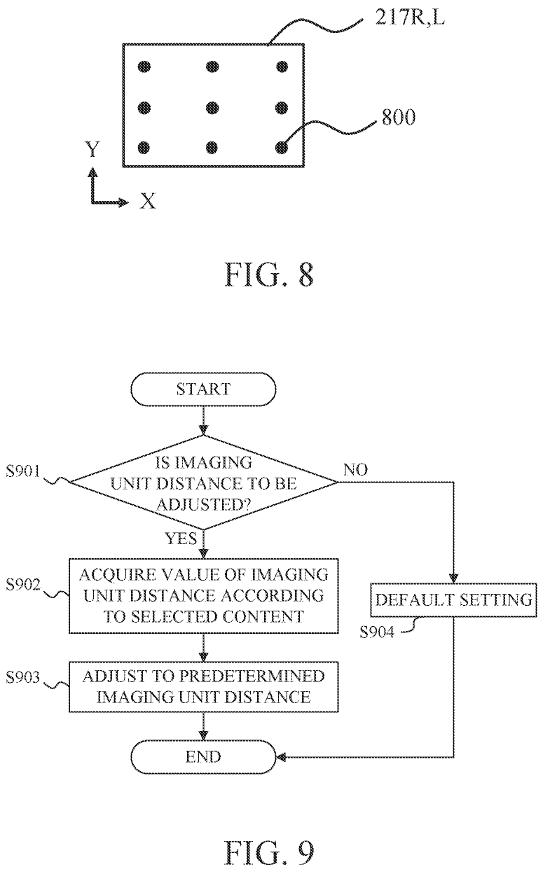

FIG. 8 illustrates a UI example in acquiring the eyeball distance 251 of the user. Reference numeral 800 denotes position information to be gazed in a case where the eyeball information acquiring unit 240 acquires the eyeball information, in order to calibrate visual line detection.

In step 701, the system control unit 218 as the eyeball distance acquiring unit 218a acquires the eyeball distance 251 illustrated in FIG. 2. The following method is conceivable as a method of acquiring the eyeball distance 251. In a case where the HMD 100 is powered on, a UI is set that displays something at the screen center (image center) of the EVF 217 to make the user view the screen center of the EVF 217, visual line information at that time is acquired, and the eyeball distance 251 is acquired. At that time, misalignment information between the left and right eyes and the screen center may also be acquired.

The following method is conceivable as another method of acquiring the eyeball distance 251. A calibration mode is prepared, for example, only a gaze point at the center position in the EVF 217 of FIG. 8 is lit up to promote the user to gaze the screen center of the EVF 217, visual line information is detected, and the eyeball distance 251 of the user is acquired. In the prepared calibration mode for acquiring the eyeball distance 251, an eyeball distance may be obtained for each of a plurality of positions on the screen (on the image) in the EVF 217 as illustrated in FIG. 8. This is because the eyeball is supported by a plurality of muscles, and its rotation axis is slightly blurred depending on the viewing direction. In an attempt to calculate the convergence angle based on a change in the convergence angle due to this blurred rotation axis, the eyeball distances 251 may be acquired at a plurality of positions, and the convergence angle may be calculated by changing the eyeball distance 251 according to the viewing position of the user.

As still another method of acquiring the eyeball distance 251, depending on the measurement accuracy of the eyeball information acquiring unit 240, the eyeball distance 251 may be acquired using visual line information in a case where the distance to the target object for the user is equal to or longer than a predetermined distance. This is because it is understood that even a person having a relatively large eyeball distance 251 of 7 cm if viewing an object 8 [m] ahead forms a convergence angle of about 0.5 [°] (≈0.0087 [rad]) based on the following equation (2):

$$θ \left[r a d\right] = 2 \times \text{atan} \left(\frac{e y e b a l l d i s t a n c e o f u s e r}{2 \times d i s t a n c e t o o b j e c t}\right)$$

It is important for this embodiment to accurately calculate a convergence angle on a real-time basis using the distance information and the eyeball distance 251, and the timing of acquiring the eyeball distance 251 is not particularly limited.

In step 702, the system control unit 218 as the EVF distance adjusting unit 218b adjusts the position of the EVF distance 252 to the eyeball distance 251 of the user using the eyeball distance 251 acquired in step 701.

In step 703, the system control unit 218 as the imaging unit distance adjusting unit 218c adjusts the position of the imaging unit 211 to adjust the imaging unit distance 253 to the eyeball distance 251 of the user using the eyeball distance 251 obtained in step 701.

In step 704, the system control unit 218 as the distance information acquiring unit 218d specifies a target area for the user in the image displayed on the EVF 217 using the eyeball information acquiring unit 240, and acquires the distance information to the object in the specified area. The distance information to the object is acquired using the above method of calculating the distance information from the defocus amount.

Referring now to FIG. 12, a description will be given of the details of the method of acquiring the distance from the target area for the user to the target object for the user. Reference numeral 1201 denotes a position in the area gazed by the user using the eyeball information acquiring unit 240. Reference numeral 1202 denotes a person, reference numeral 1203 denotes a tree, and reference numeral 1204 denotes a house. In a case where the system control unit 218 recognizes that the user is paying attention to a person based on the visual line information acquired by the eyeball information acquiring unit 240 and the image signal acquired by the imaging unit 211, the system control unit 218 acquires the distance information of the person using the above method of calculating the distance information from the defocus amount. As described above, this embodiment has explained the method of calculating the distance information from the image signal acquired by the imaging unit 211, but may separately prepare a distance measuring unit of acquiring distance information using a laser etc. and acquire the distance to the object viewed by the user in cooperation with the visual line information.

In step 705, the system control unit 218 as the convergence angle determining unit 218e determines (calculates) the convergence angle using equation (2) and the eyeball distance 251 acquired in step 701 and the distance information to the target object for the user acquired in step 704.

In step 706, the system control unit 218 as the convergence angle adjusting unit 218f adjusts the convergence angle of the imaging unit 211 (the convergence angle between the first imaging unit 211R and the second imaging unit 211L) based on the convergence angle calculated in step 705. That is, the system control unit 218 as the convergence angle adjusting unit 218f adjusts the convergence angle of the imaging unit 211 to the convergence angle calculated in step 705.

The above method is a method of measuring the eyeball distance 251 of the user using the visual line information as part of the eyeball information, of acquiring the distance information to the target object for the user, of calculating the convergence angle, and of automatically adjusting the convergence angle of the imaging unit 211.

This method can provide a stereoscopic image pickup apparatus that can stably provide a three-dimensional image that reproduces the distance feeling of the user on a real-time basis.

### Second Embodiment

A description will now be given of a second embodiment. A description of matters common to those of the first embodiment will be omitted.

FIG. 9 is a flowchart illustrating a method of selectively using the imaging unit distance 253 according to the contents of the HMD 100.

A three-dimensional image adjusted to the distance feeling of the user is not necessarily proper as a content for the HMD 100. Therefore, the imaging unit distance 253 may be changed according to settings of contents.

In step S901, the system control unit 218 determines whether it is necessary to adjust the imaging unit distance 253 for the current content display. In a case where the imaging unit distance 253 needs to be adjusted, the flow proceeds to step S902. In a case where the imaging unit distance 253 does not need to be adjusted, the flow proceeds to step S904.

In step S902, the system control unit 218 reads and acquires the value of the imaging unit distance 253 corresponding to the selected content from a memory or the like.

In step S903, the system control unit 218 adjusts the position of the imaging unit 211 using the value of the imaging unit distance 253 obtained in step S902 so that the value of the imaging unit distance 253 becomes the value of the imaging unit distance 253 obtained in step S902.

In step S904, as in the first embodiment, the system control unit 218 adjusts the value of the imaging unit distance 253 to the value of the eyeball distance 251 because it is the default to adjust the imaging unit distance 253 to the eyeball distance 251.

As described above, selectively using the imaging unit distance according to the content can provide the user with a suitable three-dimensional image for each content.

### Third Embodiment

A description will now be given of a third embodiment. A description of matters common to those of the first embodiment will be omitted.

Occlusion is a problem in changing a viewpoint of a three-dimensional image through image processing. Since there are blind spots even in a case where an object is viewed from a plurality of viewpoints, some areas may not reflect the reality in the movement of the viewpoint. The first and second embodiments assume that the movement of the viewpoint associated with the change of the convergence angle is mechanically adjustable. However, the occlusion is not a problem if shift correction using image processing is available. If the imaging unit distance 253 cannot be mechanically adjusted, the shift correction using image processing can also adjust the imaging unit distance 253.

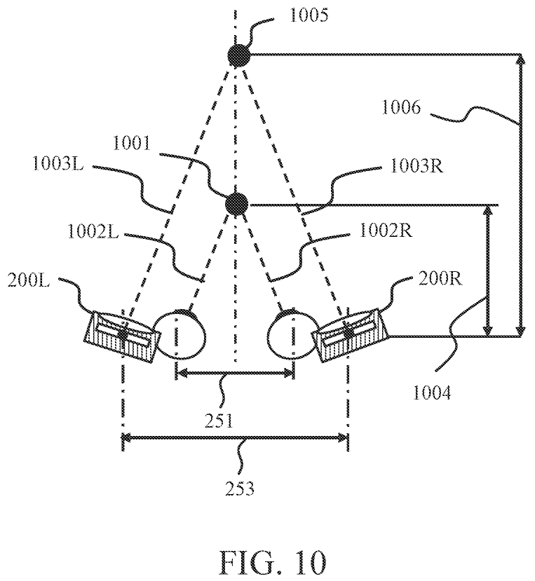

FIG. 10 illustrates the convergence angle of the image capturing unit 200 adjusted to the convergence angle of the user in a state where the imaging unit distance 253 is larger than the eyeball distance 251. In FIG. 10, reference numeral 1001 denotes a target object. Reference numerals 1002R and 1002L denote visual line directions of the user. Reference numerals 1003R and 1003L denote imaging directions of the image capturing units 200R and 200L, respectively. Reference numeral 1004 denotes an actual distance to the target object. Reference numeral 1005 denotes an intersection of the imaging directions of the image capturing units 200R and 200L. Reference numeral 1006 is a distance to the intersection of the imaging directions of the image capturing units 200R and 200L.

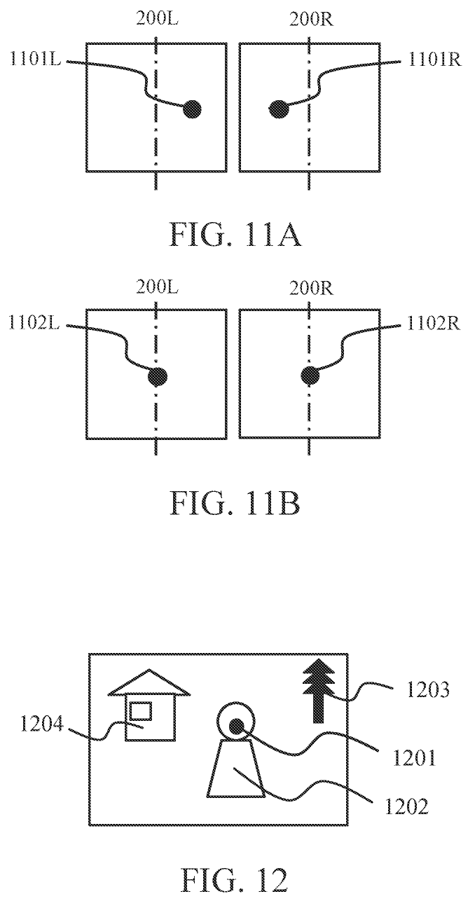

FIGS. 11A and 11B illustrate images that are being captured by the image capturing units 200R and 200L in FIG. 10 before (FIG. 11A) and after (FIG. 11B) the shift correction using image processing for reproducing the distance feeling of the user is performed. Reference numerals 1101R and 1101L are the images of the target object 1001 for the user in FIG. 10 captured by the image capturing units 200R and 200L before the shift correction is performed. Reference numerals 1102R and 1102L denote the images of the target object 1001 for the user in FIG. 10 captured by the image capturing units 200R and 200L after the shift correction is performed.

FIG. 10 illustrates that the imaging unit distance 253 is larger than the eyeball distance 251. In an attempt to adjust the convergence angle of the image capturing unit 200 to the convergence angle of the user, for example, it is understood that the target object 1001 is shifted to the right from the imaging direction 1003L for the image capturing unit 200L. In other words, it is understood that the target object 1001 is shifted toward the inside of the convergence angle from the imaging direction 1003L of the image capturing unit 200L. For the display that reproduces the distance feeling of the user, the entire screen needs to be shifted to the outside of the screen so that the object is located at the screen center, as indicated by 1102L in FIG. 11B. As a result, the object is displayed as if it exists at an imaging intersection 1005 in FIG. 10, and an apparent distance to the target object is extended from the distance 1004 to the distance 1006. That is, in a case where the imaging unit distance 253 is larger than the eyeball distance 251, the displayed image may be shift(-correct)ed in a direction in which the apparent distance to the target object for the user is increased. The shift correcting direction for the image capturing unit 200R is opposite to that of the image capturing unit 200L, but it is common that the displayed image may be shift(-correct)ed in a direction in which the apparent distance is increased.

On the other hand, in a case where the imaging unit distance 253 is smaller than the eyeball distance 251, the displayed image may be shift-corrected in a direction in which the apparent distance to the target object for the user is decreased.

As described above, even if the imaging unit distance 253 cannot be mechanically adjusted, the user can be provided with a three-dimensional image that reproduces the distance feeling of the user by performing the shift correction using the image processing.

### Other Embodiments

Embodiment(s) of the present invention can also be realized by a computer of a system or apparatus that reads out and executes computer-executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer-executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer-executable instructions. The computer-executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the disclosure has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2022-017201, filed on Feb. 7, 2022, which is hereby incorporated by reference herein in its entirety.

What is claimed is:

1. A stereoscopic image pickup apparatus comprising:
a first imaging unit configured to acquire a first image via a first optical system;
a second imaging unit configured to acquire a second image via a second optical system different from the first optical system;
a first display unit configured to display the first image;
a second display unit configured to display the second image;
at least one processor, and a memory coupled to the at least one processor, the memory having instructions that, when executed by the processor, perform operations as:
an eyeball information acquiring unit configured to acquire eyeball information of a user;
an eyeball distance acquiring unit configured to acquire an eyeball distance of the user that is a distance between rotation centers of left and right eyeballs of the user using the eyeball information;
an imaging unit distance adjusting unit configured to adjust an imaging unit distance that is a distance between the first imaging unit and the second imaging unit, based on the eyeball distance; and
a convergence angle determining unit configured to determine a convergence angle between the first imaging unit and the second imaging unit based on the eyeball distance and distance information to an object specified based on the eyeball information.

2. The stereoscopic image pickup apparatus according to claim 1, further comprising a convergence angle adjusting unit configured to adjust the convergence angle between the first imaging unit and the second imaging unit based on the convergence angle determined by the convergence angle determining unit.

3. The stereoscopic image pickup apparatus according to claim 2, wherein the convergence angle adjusting unit adjusts the convergence angle between the first imaging unit and the second imaging unit to the convergence angle determined by the convergence angle determining unit while the imaging unit distance is adjusted to the eyeball distance by the imaging unit distance adjusting unit.

4. The stereoscopic image pickup apparatus according to claim 1, wherein the imaging unit distance adjusting unit mechanically adjusts the imaging unit distance based on the eyeball distance.

5. The stereoscopic image pickup apparatus according to claim 1, wherein the imaging unit distance adjusting unit adjusts the imaging unit distance through image processing,
wherein in a case where the imaging unit distance is longer than the eyeball distance, the imaging unit distance adjusting unit shifts the first image and the second image in a direction in which an apparent distance to a target object for the user increases, and
wherein in a case where the imaging unit distance is shorter than the eyeball distance, the imaging unit distance adjusting unit shifts the first image and the second image in a direction in which the apparent distance to the target object for the user decreases.

6. The stereoscopic image pickup apparatus according to claim 1, wherein the distance information is calculated using defocus information obtained from at least one of the first imaging unit and the second imaging unit.

7. The stereoscopic image pickup apparatus according to claim 1, further comprising a distance information acquiring unit configured to acquire the distance information.

8. The stereoscopic image pickup apparatus according to claim 1, wherein the eyeball distance acquiring unit acquires a pupillary distance as the eyeball distance in a case where the user is viewing an object at infinity.

9. The stereoscopic image pickup apparatus according to claim 1, wherein the eyeball distance is calculated based on the eyeball information acquired by the eyeball information acquiring unit in a case where the first display unit and the second display unit are displaying the same image.

10. The stereoscopic image pickup apparatus according to claim 1, wherein the eyeball distance is calculated based on the eyeball information in a case where the distance to a target object for the user specified based on the eyeball information, is equal to or longer than a predetermined distance.

11. The stereoscopic image pickup apparatus according to claim 1, wherein the eyeball distance acquiring unit acquires the eyeball distance for each of a plurality of positions on images displayed on the first display unit and the second display unit, and
wherein the convergence angle determining unit determines the convergence angle between the first imaging unit and the second imaging unit using the eyeball distance that is different for each of the plurality of positions.

12. The stereoscopic image pickup apparatus according to claim 1, wherein the eyeball information includes visual line information of the user.

13. A control method of stereoscopic image pickup apparatus that includes a first imaging unit configured to acquire a first image via a first optical system, a second imaging unit configured to acquire a second image via a second optical system different from the first optical system, a first display unit configured to display the first image, and a second display unit configured to display the second image, the control method comprising the steps of:
acquiring eyeball information of a user;
acquiring an eyeball distance of the user that is a distance between rotation centers of left and right eyeballs of the user using the eyeball information;
adjusting an imaging unit distance that is a distance between the first imaging unit and the second imaging unit, based on the eyeball distance; and
determining a convergence angle between the first imaging unit and the second imaging unit based on the eyeball distance and distance information to an object specified based on the eyeball information.

14. A non-transitory computer-readable storage medium storing a program that causes a computer to execute the control method according to claim 13.

15. A control apparatus for use with a stereoscopic image pickup apparatus that includes a first imaging unit configured to acquire a first image via a first optical system, and a second imaging unit configured to acquire a second image via a second optical system different from the first optical system, the control apparatus comprising at least one processor, and a memory coupled to the at least one processor, the memory having instructions that, when executed by the processor, perform operations as:
an eyeball information acquiring unit configured to acquire eyeball information of a user;
an eyeball distance acquiring unit configured to acquire an eyeball distance of the user that is a distance between rotation centers of left and right eyeballs of the user using the eyeball information;
an imaging unit distance adjusting unit configured to adjust an imaging unit distance that is a distance between the first imaging unit and the second imaging unit, based on the eyeball distance; and
a convergence angle determining unit configured to determine a convergence angle between the first imaging unit and the second imaging unit based on the eyeball distance and distance information to an object specified based on the eyeball information.
